(19) United States
(12) Patent Application Publication
(10) Pub. No.: US 2010/0205197 A1
(43) Pub. Date: Aug. 12, 2010

(54) TWO-VALUED LOGIC DATABASE MANAGEMENT SYSTEM WITH SUPPORT FOR MISSING INFORMATION

(76) Inventor: Stavros POLYVIOU, Geri (CY)

Correspondence Address: PATTERSON & SHERIDAN, L.L.P., 3040 POST OAK BOULEVARD, SUITE 1500, HOUSTON, TX, 77056, US

(21) Appl. No.: 12/648,140

(22) Filed: Dec. 28, 2009

Related U.S. Application Data
(60) Provisional application No. 61/150,683, filed on Feb. 6, 2009.

(51) Int. Cl. G06F 17/30

(52) U.S. Cl. 707/758; 707/822; 707/E17.005; 707/E17.014

(57) ABSTRACT

A two-valued logic relational database system handles missing information in a consistent way, such that query performance optimization and other techniques that break down in a three-valued logic relational database systems, can be applied. This database system introduces a NOT FOUND value to designate empty or missing information. The NOT FOUND value is introduced in all possible domains from which a constant, variable or tuple attribute may draw its value, including cases where that value is a collection of values such as a set or multiset.

### CROSS-REFERENCE TO RELATED APPLICATIONS

This application claims the benefit of and priority to U.S. Provisional Application Ser. No. 61/150,683, filed Feb. 6, 2009, entitled “System and Method for Search Using a Visual Query Language,” which is hereby incorporated by reference.

### BACKGROUND OF THE INVENTION

1. Field of the Invention

Embodiments of the invention relate generally to database systems, and more particularly, to two-valued logic database management systems with support for missing information.

2. Description of the Related Art

A database is a collection of persistent data that is used by application systems of some given enterprise. Databases are created, maintained and accessed through a database management system (DBMS). A DBMS is a computerized system whose overall purpose is to store information and to allow users to retrieve and update that information on demand. “Persistent data” is data that, once accepted by the DBMS, is added to a database. It can then be removed from that database only by some explicit request to the DBMS. Persistent data cannot be removed implicitly, i.e., as a side effect of some action. The termination of an application, for example, results in the disappearance of all data the application had stored in a computer's main memory, but does not cause the disappearance of persistent data.

The relational model for database management was proposed by Edgar F. Codd. Its main advantages are its solid theoretical foundation and its simplicity which belies its high expressive power and comprehensive data modeling capabilities. In the relational model there is only one kind of operand: the relation. A relation consists of a set of tuples, each made up of a set of named attributes. Each attribute draws its values from a specific set of values called a domain. This set of named attributes is also referred to as the relation schema or the relation's intension. Since no duplicate elements are allowed in sets, it follows that each tuple, i.e., each combination of attribute values, must appear only once within a relation. It also follows that each attribute within a relation must be unique, i.e. it must have a unique name. The number of attributes within a relation is known as its arity. The number of all tuples within a relation is known as its cardinality. It is also quite common to visualize a relation as a table, where each column corresponds to an attribute, and each tuple corresponds to a row in the table.

The NULL marker was introduced in the relational model to handle the issue of missing information in a consistent way, one that would burden neither the user searching for missing information nor the developer who needs ways to store and manipulate missing information. A three-valued logic system was introduced in the relational model along with the NULL marker. Such a logic system introduces a third unknown value, in addition to the well established true and false values. This third unknown value is indicated in the database with the NULL marker.

Unfortunately, several logical identities that hold in the well-established two-valued logic system, and which can be used to optimize query performance, no longer hold in a three-valued logic system. Consider a table PERSON with two columns: NAME and AGE. The following SQL query, under classical logic rules, would return the PERSON table in its entirety as its result:

SELECT NAME, AGE
FROM PERSON
WHERE AGE > 50

OR
AGE <= 50

This is because the inverse of AGE>50 in classical logic is AGE<=50, i.e., when one condition is false the other must be true and vice versa. An optimizer could easily detect this and simplify this query to just the following:

SELECT NAME, AGE
FROM PERSON

In a three-valued logic system, however, the inverse of AGE>50 is unfortunately not AGE<=50. Consider the PERSON table below:

| NAME | AGE |
|---|---|
| Bob | 55 |
| Joe | 45 |
| Tom | NULL |

The query:

SELECT NAME, AGE
FROM PERSON
WHERE AGE > 50

OR
AGE <= 50

would return the following result:

| NAME | AGE |
|---|---|
| Bob | 55 |
| Joe | 45 |

This is clearly different from the result of the optimized query, which is the entire table, and therefore the optimization cannot be applied.

### SUMMARY OF THE INVENTION

Embodiments of the present invention provide a way to handle missing information in a consistent way in a two-valued logic relational database system, such that query performance optimization and other techniques that break down in a three-valued logic relational database systems, can be applied. Embodiments of the present invention introduce a value, hereinafter referred to as a NOT FOUND value, into a two-valued logic relational database system to designate empty or missing information. The NOT FOUND value is introduced in all possible domains from which an attribute may draw its value. The NOT FOUND value may be used to represent missing information in a symbol-, string-, nested string-, tuple-, set- or multiset-valued variable, constant or tuple attribute.

A database management system according to an embodiment of the present invention includes a storage volume in which data are logically arranged as a two-valued logic relational database and missing values for attributes are represented in the database by a special value, and a processing unit configured to execute queries made to the database and interpret the special value in accordance with a domain of the attribute represented by the special value.

A method of organizing data within a database relation arranged as a plurality of tuples, according to an embodiment of the present invention, includes the steps of receiving attribute values for a plurality of attributes for each of the tuples, determining by a processor that at least one of the tuples is missing an attribute value for an attribute, assigning a special value to the attribute, and storing the attribute values for the tuples including the special value in a storage volume, wherein the special value is interpreted in a logical expression in accordance with a domain of the attribute and, when evaluated in a logical expression against a value drawn from the same domain, outputs a logical value of TRUE or FALSE.

A method of processing and responding to database queries, according to an embodiment of the present invention, includes the steps of receiving a database query requiring a reference to a database relation arranged as a plurality of tuples, wherein at least one of the tuples has a plurality of attributes and at least one of the attributes has a special value as its attribute value, wherein the special value is interpreted in a logical expression in accordance with a domain of the attribute, comparing by a processor the attribute having the special value with another attribute value in accordance with the query, generating with the processor a logical value of TRUE or FALSE based upon the comparison, and returning a query response.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a database management system in which one or more embodiments of the present invention may be implemented.

FIGS. 2A, 2B, and 2C illustrate alternative ways of deploying the database management system according to one or more embodiments of the present invention.

FIG. 3A depicts an example of a relation.

FIG. 3B depicts an example of a nested relation.

FIG. 4 conceptually illustrates a process of updating a database relation in response to a user input.

FIGS. 5A and 5B depict the processing steps carried out by a database management system to process user inputs according to one embodiment of the present invention.

FIGS. 6A and 6B depict the processing steps carried out by a database management system to process a user search request according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

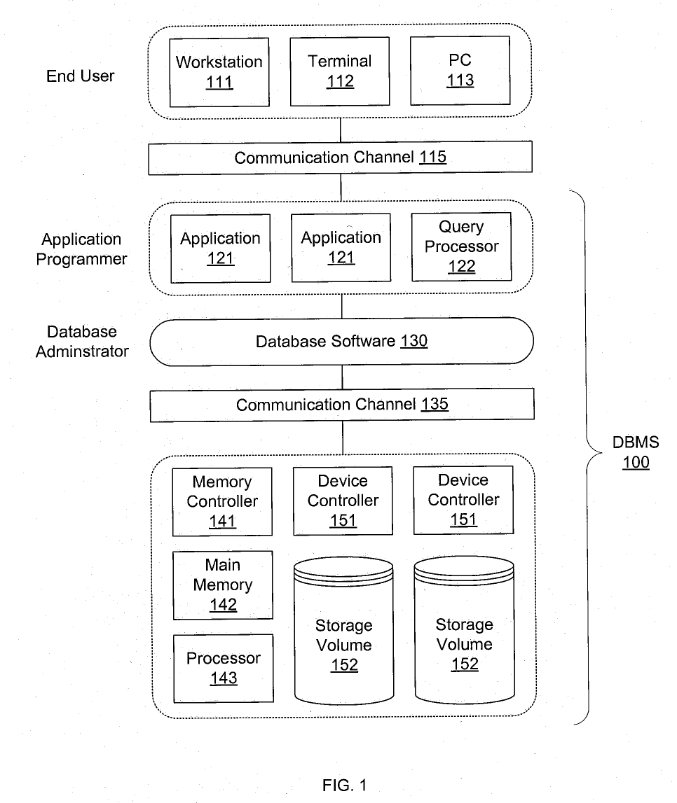

FIG. 1 depicts a database management system (DBMS) 100 in which one or more embodiments of the present invention may be implemented. DBMS 100 includes data, hardware, and software. The data in DBMS 100 is integrated and shared. The former means that DBMS 100 provides a unified view over possibly several distinct data files. The latter means that individual pieces of data can be shared among different users, possibly for different purposes. The hardware components of DBMS 100 consist of storage volumes 152—usually magnetic disks, such as hard disk drives—used for storing the data. They also consist of various peripheral devices used for transferring the data to and from these disks, such as device controllers 151 and input/output (communication) channels 135. Finally, they include hardware processor 143, associated main memory 142, and memory controller 141, all of which are used to execute database software 130. The functions of database software 130 include, among others, the “shielding of database users from hardware-level details.” In other words, the user need not know anything about the way the data is stored on the hardware, or how it is accessed from it, in order to be able to retrieve it through database software 130.

The users of DBMS 100 fall under three categories: application programmers, end users and database administrators. Application programmers develop applications 121 that issue requests to DBMS 100 in order to access data stored therein. Such applications are usually online applications that allow an end user to access a database from a workstation 111, terminal 112, or personal computer 113. Access may be through a communications channel 115 such as a local area network, wide area network, or a public network such as the Internet. In addition to such applications, end users can also use built-in interfaces provided by the DBMS, such as a query processor 122. A query processor allows end users to issue requests to the DBMS in some appropriate command language known as a query language. Finally, a database administrator (DBA) is responsible for the creation of databases and for the implementation of the technical controls necessary for the enforcement of the enterprise's various policy decisions. The DBA is also responsible for maintaining the performance of the system at a level that is acceptable to the users of the system.

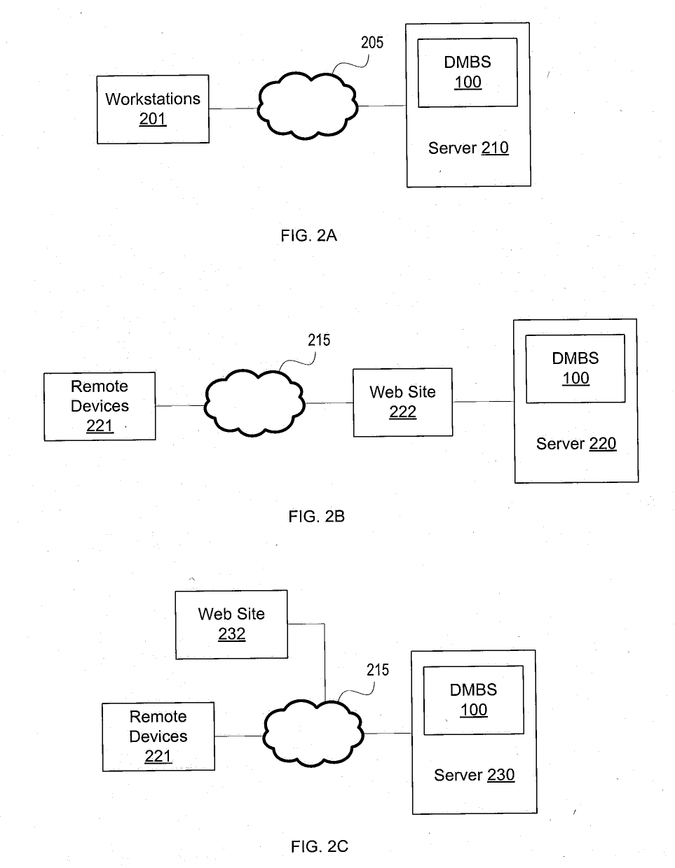

FIGS. 2A, 2B, and 2C depict three different embodiments of DBMS 100. In FIG. 2A, DBMS 100 is installed within a server 210 for enterprise usage. In this embodiment, DBMS 100 would be administered by the DBA for the enterprise and end users (e.g., employees) would access DBMS 100 through workstations 201 and other similar devices connected to server 210 over a secure network 205, such as a company intranet. In FIG. 2B, DBMS 100 is installed within a server 220 to support a web site 222 that is accessed over the Internet 225. In this embodiment, DBMS 100 would be administered by the DBA for the web site and would support servicing of end users (e.g., customers) who access the web site through remote computing devices 221 over the Internet 215. In FIG. 2C, DBMS 100 is installed within a server 230 of a database application service provider. In this embodiment, DBMS 100 would be administered by the DBA for the database application service provider and would support entities (companies and individuals) that are seeking database software support for their organizations. Access to this service would be made through remote computing devices 221 connected to the database application service provider over the Internet 215. In one embodiment, a web site 232 employs this database application service for database software support.

DBMS 100 is a two-valued logic relational database management system. The fundamental building blocks of DBMS 100 are domains. A finite domain is a uniquely identifiable, time-invariant, finite set of semantically-related symbols. A symbol is the quantum of information that can be stored or manipulated by DBMS 100. A number, which can be natively stored and manipulated by a computer, is used to denote each of these symbols, effectively turning domains into sets of numbers. In DBMS 100, every finite domain includes a special symbol, known as the NOT FOUND symbol, which is denoted hereafter using the hash sign (#). Other symbols may be used to represent missing information in other embodiments of the present invention. This special symbol has the reserved identity of 0 and, as its name implies, denotes the absence of information. Two # symbols drawn from different domains are considered distinct. Therefore, a logical comparison between two # symbols drawn from different domains would return the logical value FALSE. On the other hand, a logical comparison between two # symbols drawn from the same domain would return the logical value TRUE. Examples of finite domains include the set of English alphabet letters, and the set of Arabic numerals.

Symbols generally appear in groups, referred to herein as strings. A string is a set of <position, symbol identity> ordered pairs. Each position is an integer number. Each symbol identity identifies a specific symbol drawn from a specific finite domain. All symbols within a string must be drawn from the same finite domain. The positions within a string are unique, meaning that only one symbol may appear under each one, and contiguous, meaning that no gaps are allowed between the number sequence leading from the minimum to the maximum position. A symbol may appear more than once at different positions within the same string.

A string belongs to an infinite domain. While symbols are drawn from domains having a finite number of values, strings are in contrast drawn from domains having an infinite number of values. This infinite number arises from the fact that the number of symbols that may appear within a string is not restricted. Examples of infinite domains include the set of all English words and the set of all numbers. Since a string may contain an infinite number of symbols, there can be infinitely many NOT FOUND strings in each infinite domain, e.g., #, ##, ###, etc. However, from the point of view of DBMS 100, all NOT FOUND strings drawn from the same infinite domain are considered to be identical, and for simplicity, they can all be denoted with a single # symbol.

A nested string is a set of <position, lexical value> ordered pairs. A lexical value may be a symbol drawn from a finite domain, a string drawn from an infinite domain, or a nested string drawn from a nested infinite domain. Each position is an integer number. The positions within a nested string are unique, meaning that only one lexical value may appear under each one, and contiguous, meaning that no gaps are allowed between the number sequence leading from the minimum to the maximum position. A lexical value may appear more than once at different positions within the same nested string. Finally, a nested string belongs to a nested infinite domain.

A special case of a lexical value is the # lexical value. Like a # symbol, a # lexical value denotes the absence of information, in this case the absence of a lexical value. A # lexical value may be a # symbol drawn from a finite domain, a string drawn from an infinite domain containing only # symbols, or a nested string drawn from a nested infinite domain containing only # lexical values. For simplicity, any # lexical value can be denoted with a single # symbol, whenever the domain such a value is drawn from, as well as its structure, can be determined from context. From the point of view of DBMS 100, all NOT FOUND nested strings drawn from the same nested infinite domain are considered to be identical.

An attribute is an <attribute name, value> ordered pair. An attribute name is a nested string drawn from a built-in nested infinite domain of identifiers. A tuple is a set of attributes. The names of the attributes within a tuple are unique, meaning that only one value may appear under each one. A value, however, may appear more than once under different attributes within the same tuple. Values within a tuple may be drawn from different domains.

All tuples belong to at least one structured domain. Like all values, tuples too must be drawn from the same domain. Each tuple in a structured domain is identified by its set of <attribute name, value> ordered pairs. All tuples in a structured domain must conform to a common schema. A schema is a set of <attribute name, domain> ordered pairs. Attribute names within a schema are unique, meaning that only one domain may appear for each attribute name. The same domain, however, may appear more than once within a schema. A tuple t is said to conform to a schema s, if and only if the set of attribute names in t is identical to the set of attribute names in s and, in addition, the value of every attribute whose name is “a” in t is drawn from the domain that is paired with “a” in s. In the case of tuples, values that denote the absence of information are called # tuples. A # tuple is a tuple whose every attribute has a # value drawn from the domain corresponding to the attribute.

A set domain is a time-invariant set of all possible sets that can be constructed from the set of values of another domain, which we refer to as its element domain. If the element domain of a set domain is finite, then the set domain too is finite. If the element domain of a set domain is infinite, then the set domain too is infinite. Each value drawn from a set domain is identified by the totality of the values it contains. If two sets contain exactly the same values, then they are the same set. In the case of sets, # sets denote the absence of information. A # set is a singleton set containing a single # value drawn from the set domain's element domain. A # set is equivalent to an empty set.

A multiset domain is a time-invariant set of all possible sets of <value, natural number> ordered pairs that can be constructed from the set of values of another domain, which we refer to as its element domain. Given that the set of natural numbers is infinite, multiset domains too are by definition infinite. Each value drawn from a multiset domain is identified by the set of ordered pairs it contains. If two multisets have the same set of ordered pairs then they are the same multiset.

A multiset is a set of <value, multiplicity> ordered pairs. The values within a multiset are unique, meaning that only one multiplicity value may appear for each one. All values within a multiset must be drawn from the same domain. The multiplicity component of each pair is a natural number, indicating the number of elements in the multiset that have the same value. A multiset belongs to a multiset domain. information. In the case of multisets, # multisets denote the absence of information. A # multiset is a singleton set containing a <# value, natural number> ordered pairs. The # value is drawn from the multiset domain's element domain. Within a multiset domain, there is an infinite number of # multisets. A # multiset is equivalent to an empty multiset.

In the domains described above, a # value is one of the following: (1) A # lexical value drawn from a lexical domain (finite, infinite and nested infinite domains are collectively referred to as lexical domains), (2) a # tuple drawn from a structured domain, (3) a # set drawn from a set domain, and (4) a # multiset drawn from a multiset domain. For simplicity, any # value can be denoted with a single # symbol, whenever the domain such a value is drawn from, as well as its structure, can be determined from context.

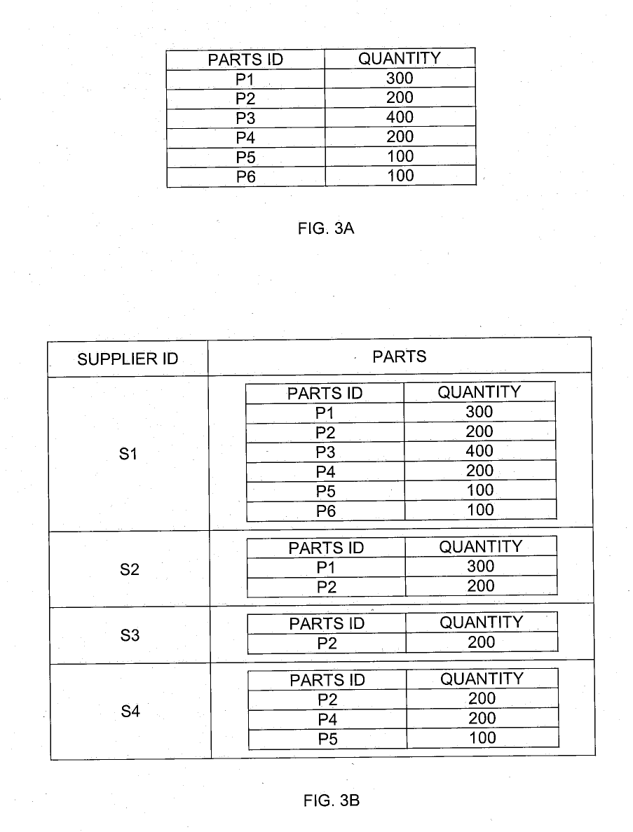

A relation is a set of tuples and a corrupted relation is a multiset of tuples. FIG. 3A is an example of a relation and FIG. 3B is an example of a nested relation. Both contain the same information.

Because DBMS 100 handles missing information using the # value as described above, DBMS 100 provides certain advantages over the conventional relational DBMS. The first is its ability to benefit from query performance optimization. In DBMS 100, given the relation PERSON below:

| NAME | AGE |
|---|---|
| Bob | 55 |
| Joe | 45 |
| Tom | # |

when the query

SELECT NAME, AGE
FROM PERSON
WHERE AGE > 50

OR
AGE <= 50

is optimized to:

SELECT NAME, AGE
FROM PERSON

the result will be the same before and after optimization. The reason is that one of the expressions #>50 or #<=50 must be TRUE and the other must be FALSE in a two-valued logic system.

In addition, the use of the # value in DBMS 100 is more consistent than the use of the NULL marker in the conventional relational DBMS. In some cases, e.g., JOIN, the comparison NULL=NULL returns NULL while, in other cases, e.g., UNION, the comparison NULL=NULL returns TRUE. In contrast, #=# returns TRUE under all circumstances in DBMS 100 so long as the # is drawn from the same domain. As a result, queries are easier to formulate, interpret and understand in DBMS 100.

For example, consider first the following two relations in a three-valued logic system: BUYS, which contains the IDs of buyers and of a part they wish to buy, and SELLS, which contains the IDs of sellers and of a part they wish to sell. Assume here that buyer 2 wants to buy a part that no supplier supplies, and seller 5 wants to sell a part that no buyer wants to buy, and that buyer 3 is also a seller, one who wants to neither buy nor sell a part.

BUYS

| BUYER_ID | BUYS_PART_ID |
|---|---|
| 1 | 10 |
| 2 | 20 |
| 3 | NULL |

SELLS

| SELLER_ID | SELLS_PART_ID |
|---|---|
| 3 | NULL |
| 4 | 10 |
| 5 | 30 |

Consider the following query that matches sellers and buyers based on the part they want to sell or buy respectively:

| | |
|---|---|
| SELECT | BUYER_ID, BUYS_PART_ID, SELLER_ID |
| FROM | BUYS |
| | JOIN |
| | SELLS |
| | ON |
| | BUYS_PART_ID = SELLS_PART_ID |

This query gives the following result:

RESULT

| BUYER_ID | BUYS_PART_ID | SELLER_ID |
|---|---|---|
| 1 | 10 | 4 |

Buyer 2 is excluded from the result because no seller is found for part 10. Seller 5 is excluded because no buyer is found for part 30. Buyer 3 is excluded because under the rules of a three-valued logic system NULL=NULL, will always return NULL (i.e., unknown).

Consider now the following query that generates a list of all buyers and sellers, as well as the part they each want to buy or sell respectively:

| | |
|---|---|
| SELECT | BUYER_ID, BUYS_PART_ID |
| FROM | BUYS |
| UNION | |
| SELECT | SELLER_ID, |
| | SELLS_PART_ID |
| FROM | SELLS |

The result of this query is the following:

RESULT

| COL1 | COL2 |
|---|---|
| 1 | 10 |
| 2 | 20 |
| 3 | NULL |
| 4 | 10 |
| 5 | 30 |

At first glance, no discrepancy is observed. Consider, however, the following: when applying a UNION operation, SQL eliminates all duplicate rows from a query result set. Two rows are considered duplicates if and only if their corresponding columns have identical values. Notice that the row (3, NULL) only appears once in the result set, even though buyer 3 is also a seller. This implies that during duplicate elimination, the query processor evaluated the condition 3=3 AND NULL=NULL to TRUE. This in turn implies that, in the context of the UNION query, it evaluated the comparison NULL=NULL to TRUE, whereas in the context of the JOIN query, it evaluated NULL=NULL to NULL (i.e., unknown). This is of course a discrepancy in the treatment of NULL markers. Due to this discrepancy, the user is taxed with remembering different rules regarding NULL markers depending on the type of query being formulated.

Had the same rules as in the JOIN query case been applied, the result set of the UNION query would have been

RESULT

| COL1 | COL2 |
|---|---|
| 1 | 10 |
| 2 | 20 |
| 3 | NULL |
| 3 | NULL |
| 4 | 10 |
| 5 | 30 |

That is, buyer 3 would appear twice in the result set.

By contrast, in DBMS 100, a two-valued logic system that incorporates the NOT FOUND value as the # symbol:

BUYS

| BUYER_ID | BUYS_PART_ID |
|---|---|
| 1 | 10 |
| 2 | 20 |
| 3 | # |

SELLS

| SELLER_ID | SELLS_PART_ID |
|---|---|
| 3 | # |
| 4 | 10 |
| 5 | 30 |

Consider the following query that matches sellers and buyers based on the part they want to sell or buy respectively:

| | |
|---|---|
| SELECT | BUYER_ID, BUYS_PART_ID, SELLER_ID |
| FROM | BUYS |
| | JOIN |
| | SELLS |
| | ON |
| | BUYS_PART_ID = SELLS_PART_ID |

This query gives the following result:

RESULT

| BUYER_ID | BUYS_PART_ID | SELLER_ID |
|---|---|---|
| 1 | 10 | 4 |
| 3 | # | 3 |

Once again, buyer 2 is excluded from the result because no seller is found for part 10. Seller 5 is excluded because no buyer is found for part 30. Buyer 3, on the other hand, is included because the comparison #=# returns TRUE.

Consider now the following query that generates a list of all buyers and sellers, as well as the part they each want to buy or sell respectively:

| | |
|---|---|
| SELECT | BUYER_ID, BUYS_PART_ID |
| FROM | BUYS |
| UNION | |
| SELECT | SELLER_ID, |
| | SELLS_PART_ID |
| FROM | SELLS |

The result of this query is the following:

RESULT

| COL1 | COL2 |
|---|---|
| 1 | 10 |
| 2 | 20 |
| 3 | # |
| 4 | 10 |
| 5 | 30 |

Here, the row (3, #) is again included only once since the condition 3=3 AND #=# evaluates to TRUE, which is consistent with the evaluation carried out for the JOIN query. Consequently, the user need not remember different rules for different kinds of queries with respect to the treatment of missing information.

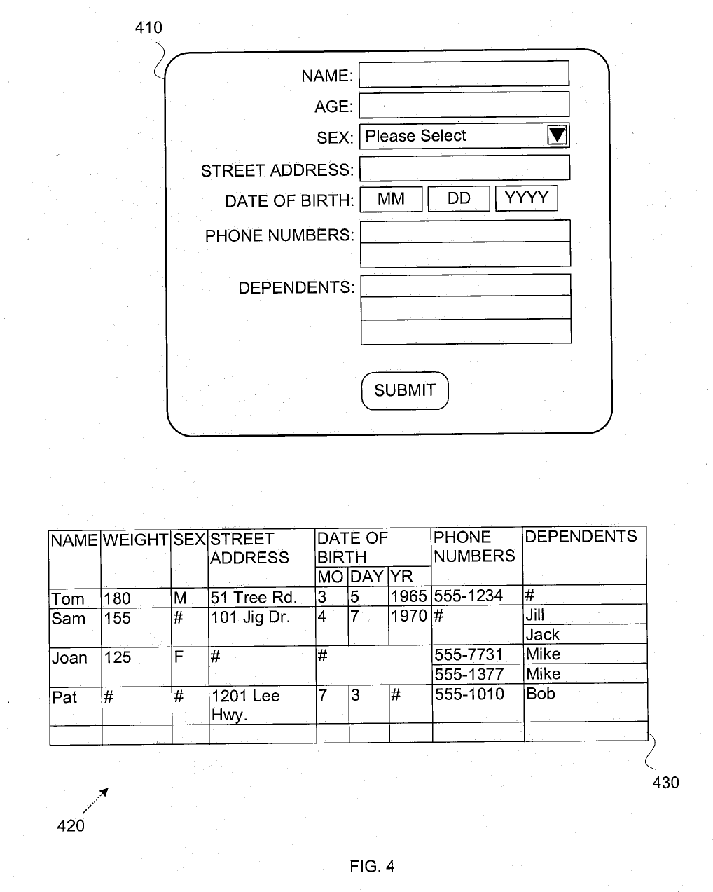

FIG. 4 conceptually illustrates a process of updating a database relation in response to a user input. A user employs a user interface 410, which may be displayed through an Internet browser, to specify the inputs. In this example, when a user clicks on SUBMIT after inputting information into the input fields shown in user interface 410, DBMS 100 updates a database relation 420 by inserting a tuple 430 with the attribute values taken from the user inputs.

Database relation 420 is shown to have seven attributes: NAME, WEIGHT, SEX, STREET ADDRESS, DATE OF BIRTH, PHONE NUMBERS, and DEPENDENTS. The values in the NAME attribute, including any # value, are drawn from an infinite domain of strings. The values in the WEIGHT attribute, including any # value, are drawn from an infinite domain of all numbers. The values in the SEX attribute are drawn from a finite domain containing (#, M, F). The values in the STREET ADDRESS attribute, including any # value, are drawn from an infinite domain of nested strings. The DATE OF BIRTH attribute is a tuple-valued attribute. Storing a piece of information as a string or nested string implies a specific order of each information component, as is the case with words made up of characters (i.e., strings made up of symbols) and pieces of text made up of words (i.e., nested strings made up of lexical values); re-ordering the characters of a word or the words of a piece of text effectively alters the content of the information stored. The components of a date, on the other hand, need to be re-orderable, in order to be able to present the date using local conventions, such as the US date format (MM-DD-YYYY), the European format (DD-MM-YYYY), and the Japanese format (YYYY-MM-DD). A list of phone numbers is stored in the PHONE NUMBERS attribute as a set-valued attribute. There is no point in listing the same phone number more than once for each person. Hence, a set-valued attribute is used. A list of dependent names is stored in a DEPENDENTS atribute as a multiset-valued attribute to allow the possibility, no matter how remote, of two or more dependents of the same person having the same name. Since each dependent has to be listed individually, a multiset is required.

If an attribute value is missing, DBMS 100 stores a # value as the attribute value. In each instance where there is missing attribute value, the symbol # is stored as the attribute value and DBMS 100, upon encountering #, interprets # in a special way depending on the context in which it appears and the relevant domain for #. In database relation 420, the tuple for Tom illustrates the use of the NOT FOUND symbol for the DEPENDENTS attribute (i.e., a NOT FOUND multiset); the tuple for Sam illustrates the use of the NOT FOUND symbol for the SEX attribute (i.e., a NOT FOUND symbol) and the PHONES attribute (i.e., a NOT FOUND set); and the tuple for Joan illustrates the use of the NOT FOUND symbol for the entire DATE OF BIRTH attribute (i.e., a NOT FOUND tuple), while the tuple for Pat illustrates the use of the NOT FOUND symbol for a single field of the DATE OF BIRTH tuple. The tuple for Joan also illustrates the use of the NOT FOUND nested string for the STREET ADDRESS attribute and the tuple for Pat also illustrates the use of the NOT FOUND string for the WEIGHT attribute and the NOT FOUND symbol for the SEX attribute.

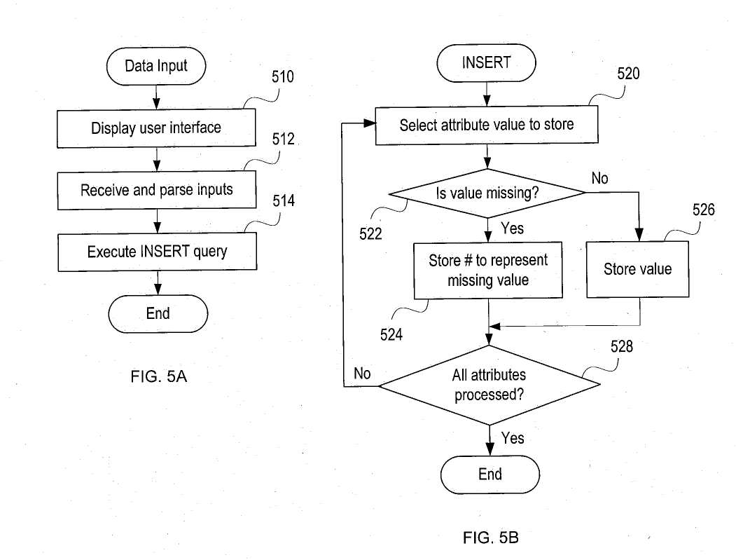

FIGS. 5A and 5B depict the processing steps carried out by DBMS 100 to process user inputs according to one embodiment of the present invention. In step 510, a user interface through which data is inputted is displayed to the user. The user makes the inputs and then clicks on a SUBMIT button. In step 512, DBMS 100 receives the input data and parses it. Then in step 514, DBMS 100 executes an INSERT query.

The processing steps of the INSERT query are shown in FIG. 5B. In step 520, DBMS 100 selects an attribute value to store. If the attribute value is missing as determined by step 522, the # value is stored in step 524 to represent the missing value. Otherwise, step 526 is carried out and the attribute value as input by the user is stored. In step 528, a check is made to see if all attributes have been processed. If so, the process ends. Otherwise, the flow returns to step 520, where a new attribute value is selected.

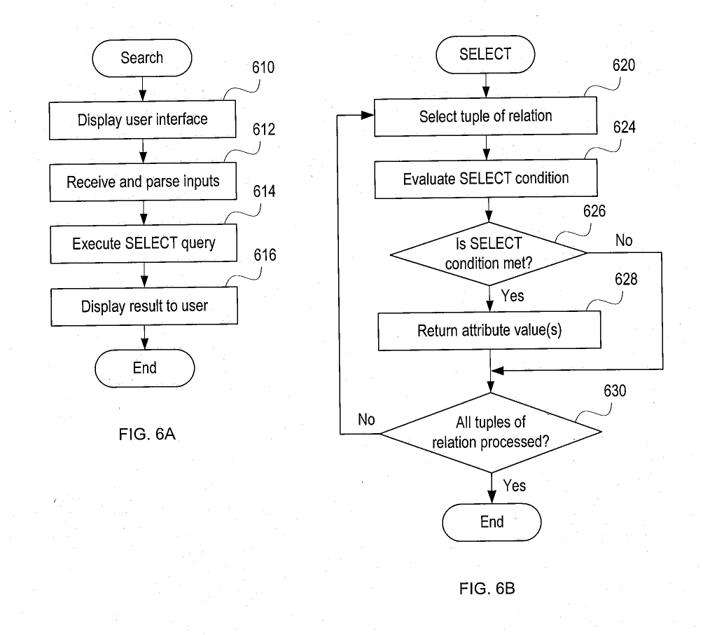

FIGS. 6A and 6B depict the processing steps carried out by DBMS 100 to process a user search request according to one embodiment of the present invention. In step 610, a user interface through which data is inputted is displayed to the user. The user makes the inputs and then clicks on a SUBMIT button. In step 612, DBMS 100 receives the input data and parses it. Then in step 614, DBMS 100 executes a SELECT query to retrieve the requested data. The requested data is displayed to the user in step 616.

The processing steps of the SELECT query are shown in FIG. 6B. In step 620, DBMS 100 selects a tuple of the relation specified in the SELECT query. Then, in step 624, the condition specified in the SELECT query is evaluated. If the SELECT condition is met as determined by step 626, the values of the attribute or attributes specified in the SELECT query for the currently selected tuple are returned in step 628. Otherwise, step 628 is skipped. In step 630, a check is made to see if all tuples of the relation specified in the SELECT query have been processed. If so, the process ends. Otherwise, the flow returns to step 620, where a new tuple is selected from the relation specified in the SELECT query.

If, in the process described above, the search request was to find all users in the relation shown in FIG. 4 who did not specify their gender, the SELECT condition would have been WHERE SEX=#. As a result of this query, the value in the NAME attribute of all tuples in the relation shown in FIG. 4 that have # stored as the attribute value for the SEX attribute would be returned for display to the user in step 616. This is because the logical expression #=# would have returned TRUE and logical expressions M=# and F=# would have both returned FALSE.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

I claim:

1. A database management system comprising:
a storage volume in which records are logically stored as a two-valued logic relational database and missing values for attributes are represented in the database by a special value; and
a processing unit configured to execute queries made to the database and interpret the special value in accordance with a domain of the attribute represented by the special value.

2. The system according to claim 1, wherein the special value, when evaluated in a logical expression against a value drawn from the same domain, outputs a logical value of TRUE or FALSE.

3. The system according to claim 1, wherein the domain is one of a domain of symbols, a domain of strings, a domain of nested strings, a domain of tuples, a domain of sets, and a domain of multisets.

4. The system according to claim 1, wherein the domain is a domain of truth values including true, false, and the special value.

5. The system according to claim 4, wherein a relation represented in the database includes first and second tuples, each having a special value drawn from the domain of truth values, and a logical comparison of the special value in the first tuple and the special value in the second tuple results in logical value of TRUE.

6. The system according to claim 3, wherein a relation represented in the database includes first and second tuples, each having at least one special value drawn from a common domain, and a logical comparison of the special value in the first tuple and the special value in the second tuple results in logical value of TRUE.

7. A method of organizing data within a database relation arranged as a plurality of tuples, comprising the steps of:
receiving attribute values for a plurality of attributes for each of the tuples;
determining by a processor that at least one of the tuples is missing an attribute value for an attribute;
assigning a special value to the attribute; and
storing the attribute values for the tuples including the special value in a storage volume,
wherein the special value is interpreted in a logical expression in accordance with a domain of the attribute and, when evaluated in a logical expression against a value drawn from the same domain, outputs a logical value of TRUE or FALSE.

8. The method according to claim 7, wherein the domain is one of a domain of symbols, a domain of strings, a domain of nested strings, a domain of tuples, a domain of sets, and a domain of multisets.

9. The method according to claim 7, wherein the domain is a domain of truth values including true, false, and the special value.

10. The method according to claim 9, wherein the database relation includes first and second tuples, each having a special value drawn from the domain of truth values, and a logical comparison of the special value in the first tuple and the special value in the second tuple results in logical value of TRUE.

11. The method according to claim 8, wherein the database relation includes first and second tuples, each having at least one special value drawn from a common domain, and a logical comparison of the special value in the first tuple and the special value in the second tuple results in logical value of TRUE.

12. The method according to 7, wherein the special value is represented by a common symbol representing missing information.

13. The method according to claim 7, wherein the database relation is drawn from a two-valued logic relational database.

14. A method of processing and responding to database queries, comprising the steps of:
receiving a database query requiring a reference to a database relation arranged as a plurality of tuples, wherein at least one of the tuples has a plurality of attributes and at least one of the attributes has a special value as its attribute value, and the special value is interpreted in a logical expression in accordance with a domain of the attribute;
comparing by a processor the attribute having the special value with another attribute value in accordance with the query;
generating with the processor a logical value of TRUE or FALSE based upon the comparison; and
returning a query response.

15. The method according to claim 14, wherein the domain is one of a domain of symbols, a domain of strings, a domain of nested strings, a domain of tuples, a domain of sets, and a domain of multisets.

16. The method according to claim 14, wherein the domain is a domain of truth values including true, false, and the special value.

17. The method according to claim 16, wherein the database relation includes first and second tuples, each having a special value drawn from the domain of truth values, and a logical comparison of the special value in the first tuple and the special value in the second tuple results in logical value of TRUE.

18. The method according to claim 15, wherein the database relation includes first and second tuples, each having at least one special value drawn from a common domain, and a logical comparison of the special value in the first tuple and the special value in the second tuple results in logical value of TRUE.

19. The method according to 14, wherein the special value is represented by a common symbol representing missing information.

20. The method according to claim 14, wherein the database relation is drawn from a two-valued logic relational database.
